(19) United States
(12) Patent Application Publication
(10) Pub. No.: US 2020/0109741 A1
(43) Pub. Date: Apr. 9, 2020

(54) Angle Adjusting Joint with Noiseless Rotation

(71) Applicant: Way-Hong Chen, Taipei City (TW)

(72) Inventor: Way-Hong Chen, Taipei City (TW)

(21) Appl. No.: 16/154,756

(22) Filed: Oct. 9, 2018

(51) Int. Cl. F16C 11/04

(52) U.S. Cl. CPC F16C 11/04; B62B 9/12

(57) ABSTRACT

An angle adjusting joint includes a fixed member and a movable member pivotally connected with the fixed member. The fixed member is provided with a receiving recess which has a substantially circular cross-section. The receiving recess has an inside provided with a plurality of projections and a plurality of locking grooves arranged between the projections. The movable member is connected with at least one fitting portion which has a substantially arcuate cross-section. The at least one fitting portion is fitted into the receiving recess and has an outside provided with at least one locking block locked in the locking grooves.

### BACKGROUND OF THE INVENTION

### 1. Field of the Invention

The present invention relates to a joint and, more particularly, to an angle adjusting joint.

### 2. Description of the Related Art

A utensil or an apparatus, such as a baby stroller, a playpen or the like, comprises a joint assembly to provide an angle adjusting function so that the utensil is expanded when in use and collapsed when not in use, thereby facilitating the user storing, carrying and transporting the utensil. However, the conventional joint assembly has a complicated structure with many parts, thereby greatly increasing the cost of fabrication and assembly. In addition, the conventional joint assembly is not operated easily and conveniently, thereby greatly causing inconvenience to the user when operating the conventional joint assembly. Further, the conventional joint assembly easily produces noise during operation.

### BRIEF SUMMARY OF THE INVENTION

The primary objective of the present invention is to provide an angle adjusting joint with noiseless rotation.

In accordance with the present invention, there is provided an angle adjusting joint comprising a fixed member and a movable member pivotally connected with the fixed member. The fixed member has a fixed piece which is provided with a receiving recess which has a substantially circular cross-section. The receiving recess has an inside provided with a plurality of projections and a plurality of locking grooves arranged between the projections. The movable member has a movable piece which is connected with at least one fitting portion which has a substantially arcuate cross-section. The at least one fitting portion is fitted into the receiving recess. The at least one fitting portion has an outside provided with at least one locking block locked in the locking grooves.

Preferably, the movable piece of the movable member has a main portion which is formed with at least one connecting section which is connected with the at least one fitting portion.

Preferably, the at least one connecting section has an inside provided with a rib.

Preferably, the at least one fitting portion of the movable member is made of flexible material.

Preferably, the at least one fitting portion of the movable member is made of plastic material.

Preferably, the fixed piece of the fixed member is provided with a first linking portion, and the movable piece of the movable member is provided with a second linking portion. The first linking portion of the fixed member is connected with a fixed rod of a utensil. The second linking portion of the movable member is connected with a movable lever of the utensil.

According to the primary advantage of the present invention, the locking blocks closely contact and slide along the inside of the receiving recess or the locking grooves by the flexibly deformed feature of the two fitting portions during rotation of the movable member, so that the locking blocks will not accidentally detach from and spring back to hit the inside of the receiving recess or the locking grooves, thereby preventing from producing noise during rotation of the movable member relative to the fixed member.

According to another advantage of the present invention, the angle adjusting joint only includes the fixed member and the movable member, so that the angle adjusting joint has a simple structure, thereby decreasing the cost of fabrication and assembly.

According to a further advantage of the present invention, the user only needs to drive and rotate the movable member so as to adjust the angle of the movable member relative to the fixed member, so that the angle adjusting joint is operated easily and conveniently, thereby facilitating the user operating the angle adjusting joint.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of an angle adjusting joint in accordance with the preferred embodiment of the present invention.

FIG. 2 is a perspective view of the angle adjusting joint in accordance with the preferred embodiment of the present invention.

FIG. 3 is a cross-sectional view of the angle adjusting joint in accordance with the preferred embodiment of the present invention.

FIG. 4 is a schematic operational view of the angle adjusting joint as shown in FIG. 2 in adjustment.

FIG. 5 is a schematic operational view of the angle adjusting joint as shown in FIG. 3 in adjustment.

FIG. 6 is a perspective view showing the angle adjusting joint for a baby stroller.

FIG. 7 is a side view showing the angle adjusting joint for the baby stroller.

### DETAILED DESCRIPTION OF THE INVENTION

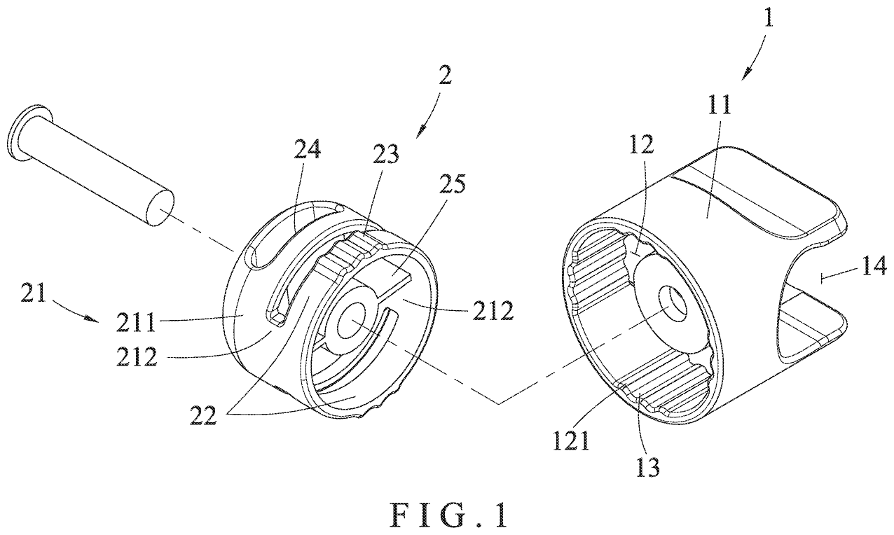

Referring to the drawings and initially to FIGS. 1-3, an angle adjusting joint in accordance with the present invention comprises a fixed member 1 and a movable member 2 pivotally connected with the fixed member 1.

The fixed member 1 has a fixed piece 11 which is provided with a receiving recess 12 which has a substantially circular cross-section. The receiving recess 12 has an inside provided with a plurality of projections 121 and a plurality of locking grooves 13 arranged between the projections 121.

The movable member 2 has a movable piece 21 which is connected with at least one fitting portion 22 which has a substantially arcuate cross-section. The movable piece 21 of the movable member 2 is pivotally connected with the fixed piece 11 of the fixed member 1. The at least one fitting portion 22 is fitted into the receiving recess 12. The at least one fitting portion 22 has an outside provided with at least one locking block 23 locked in the locking grooves 13 so that the movable member 2 is positioned at a predetermined position. Preferably, the at least one fitting portion 22 is provided with a plurality of locking blocks 23.

Preferably, the movable piece 21 of the movable member 2 has a main portion 211 which is formed with at least one connecting section 212 which is connected with the at least one fitting portion 22.

Preferably, the at least one connecting section 212 has an inside provided with a rib 25.

Preferably, the at least one fitting portion 22 of the movable member 2 is made of flexible material which has a deformation restoring feature. The movable member 2 is formed integrally so that the whole structure of the movable member 2 is made of the same material.

Preferably, the at least one fitting portion 22 of the movable member 2 is made of plastic material.

Preferably, the fixed piece 11 of the fixed member 1 is provided with a first linking portion 14, and the movable piece 21 of the movable member 2 is provided with a second linking portion 24. Preferably, the first linking portion 14 is a cavity, and the second linking portion 24 is a slot.

In the preferred embodiment of the present invention, the movable piece 21 is connected with two opposite fitting portions 22, and the main portion 211 of the movable piece 21 has an end formed with two opposite connecting sections 212 connected with the two fitting portions 22 respectively. The two fitting portions 22 are spaced from the main portion 211 with a predetermined distance. The two fitting portions 22 and the two connecting sections 212 construct an annular cross-section.

In the preferred embodiment of the present invention, the locking grooves 13 are collected at four zones in an annular manner, and the locking blocks 23 of the two fitting portions 22 are collected at predetermined zones.

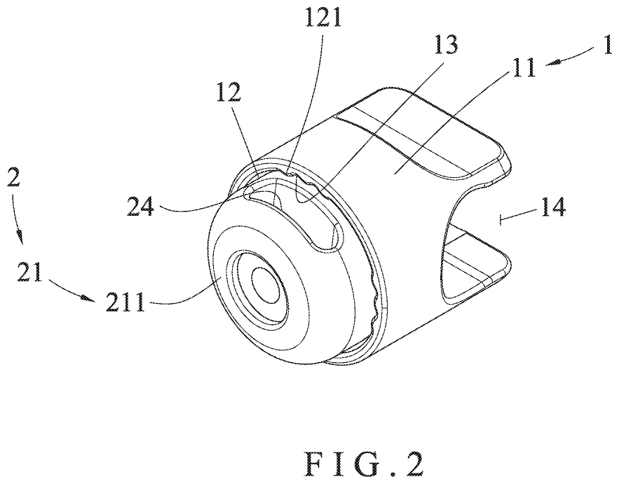

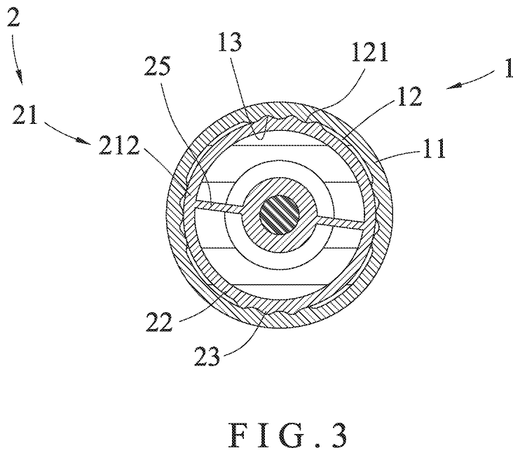

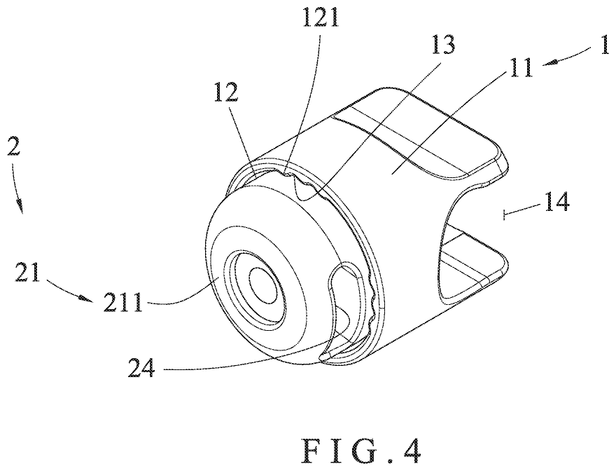

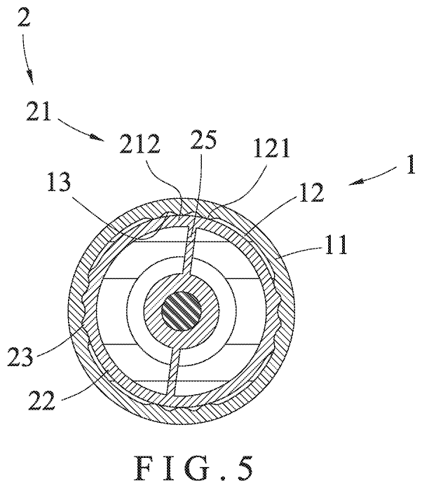

In operation, referring to FIGS. 4 and 5 with reference to FIGS. 1-3, the locking blocks 23 of the two fitting portions 22 are locked in the locking grooves 13 at two of the four zones, so that the movable member 2 is positioned on the fixed member 1. When the movable member 2 is driven by the user to rotate relative to the fixed member 1, the locking blocks 23 and the two fitting portions 22 are pressed inward by the projections 121 of the fixed member 1. At this time, the two fitting portions 22 made of flexible material are elastically contracted inward when compressed by the projections 121, so that each of the locking blocks 23 is detached from one of the locking grooves 13 and slides toward another one of the locking grooves 13. When each of the locking blocks 23 aligns with another one of the locking grooves 13, the two fitting portions 22 are expanded outward and returned to the original state by the elastically restoring force, so that the locking blocks 23 are locked in the locking grooves 13, and the movable member 2 is positioned on the fixed member 1 again. Thus, the locking blocks 23 of the two fitting portions 22 are locked in the locking grooves 13 at the other two of the four zones. In such a manner, the movable member 2 is rotated relative to the fixed member 1 and is moved from the position as shown in FIGS. 2 and 3 to the position as shown in FIGS. 4 and 5, so as to adjust the angle therebetween. In the preferred embodiment of the present invention, the locking grooves 13 are collected at four zones, so that the movable member 2 is rotated relative to the fixed member 1 through an angle of 90°, 180°, 270° and 360°. The angle 360° means that the movable member 2 is returned to the original position. Thus, the movable member 2 is positioned at different angle positions.

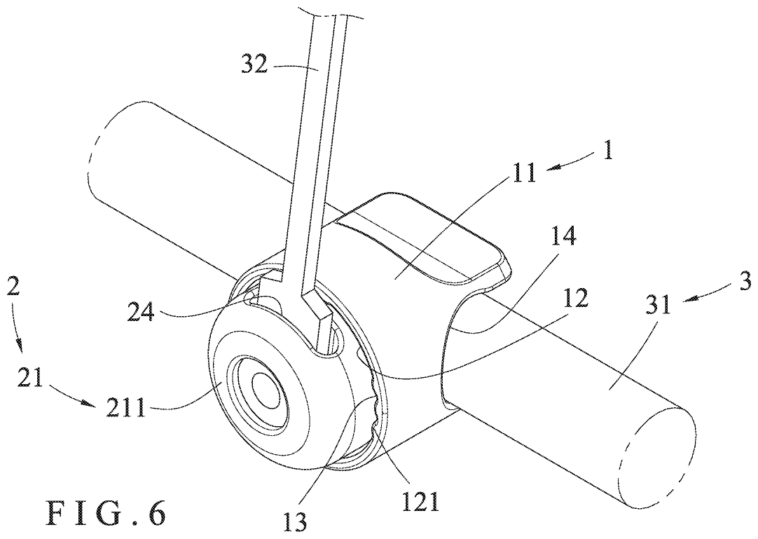

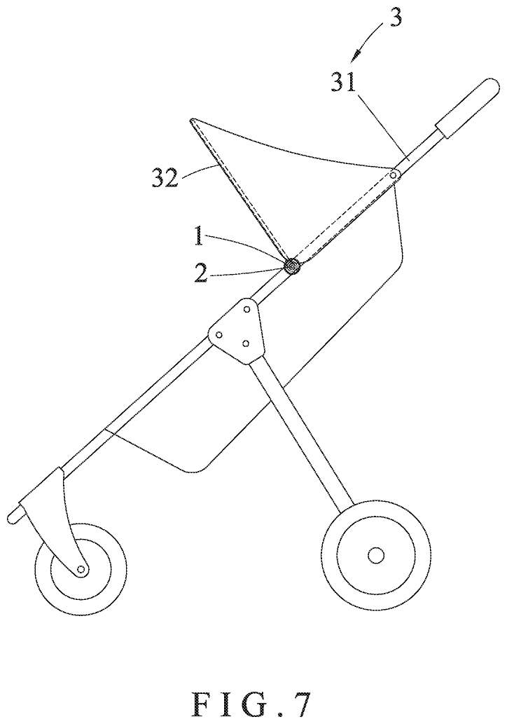

Referring to FIGS. 6 and 7 with reference to FIGS. 1-3, the angle adjusting joint is connected with a utensil 3. Preferably, the utensil 3 is a baby stroller. Alternatively, the utensil 3 is a playpen, a clothes tree or the like, that is foldable and needs an angle adjusting function. The utensil 3 includes a fixed rod 31 and a movable lever 32. The first linking portion 14 of the fixed member 1 is secured on the fixed rod 31 of the utensil 3 by such as screws or the like, and the movable lever 32 of the utensil 3 is inserted into and secured in the second linking portion 24 of the movable member 2. In such a manner, the movable member 2 is rotated relative to the fixed member 1, so that the movable lever 32 of the utensil 3 is pivoted relative to the fixed rod 31 to adjust the angle between the movable lever 32 and the fixed rod 31 of the utensil 3.

It is noted that, the movable member 2 is made of flexible material so that each of the two connecting sections 212 may also be expanded or contracted. Thus, when the two fitting portions 22 are compressed and contracted inward by the projections 121 during rotation of the movable member 2, the two connecting sections 212 are also deformed and expanded outward, so that the movable member 2 is rotated easily, and the user only needs to apply a less force to drive and rotate the movable member 2, thereby causing inconvenience and danger to the user. In the preferred embodiment of the present invention, each of the two connecting sections 212 is connected with a rib 25 which restricts the outward expanding or deforming of each of the two connecting sections 212, so that the two fitting portions 22 are not easily contracted inward. Thus, the movable member 2 is not rotated easily, and the user has to exert a larger force to drive and rotate the movable member 2, thereby facilitate the user operating the movable member 2, and thereby assuring the safety of operation.

Accordingly, the locking blocks 23 closely contact and slide along the inside of the receiving recess 12 or the locking grooves 13 by the flexibly deformed feature of the two fitting portions 22 during rotation of the movable member 2, so that the locking blocks 23 will not accidentally detach from and spring back to hit the inside of the receiving recess 12 or the locking grooves 13, thereby preventing from producing noise during rotation of the movable member 2 relative to the fixed member 1. In addition, the angle adjusting joint only includes the fixed member 1 and the movable member 2, so that the angle adjusting joint has a simple structure, thereby decreasing the cost of fabrication and assembly. Further, the user only needs to drive and rotate the movable member 2 so as to adjust the angle of the movable member 2 relative to the fixed member 1, so that the angle adjusting joint is operated easily and conveniently, thereby facilitating the user operating the angle adjusting joint.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An angle adjusting joint comprising:
a fixed member; and
a movable member pivotally connected with the fixed member;
wherein:
the fixed member has a fixed piece which is provided with a receiving recess which has a substantially circular cross-section;
the receiving recess has an inside provided with a plurality of projections and a plurality of locking grooves arranged between the projections;
the movable member has a movable piece which is connected with at least one fitting portion which has a substantially arcuate cross-section;
the at least one fitting portion is fitted into the receiving recess; and
the at least one fitting portion has an outside provided with at least one locking block locked in the locking grooves.

2. The angle adjusting joint of claim 1, wherein the movable piece of the movable member has a main portion which is formed with at least one connecting section which is connected with the at least one fitting portion.

3. The angle adjusting joint of claim 2, wherein the at least one connecting section has an inside provided with a rib.

4. The angle adjusting joint of claim 1, wherein the at least one fitting portion of the movable member is made of flexible material.

5. The angle adjusting joint of claim 4, wherein the at least one fitting portion of the movable member is made of plastic material.

6. The angle adjusting joint of claim 1, wherein:
the fixed piece of the fixed member is provided with a first linking portion;
the movable piece of the movable member is provided with a second linking portion;
the first linking portion of the fixed member is connected with a fixed rod of a utensil; and
the second linking portion of the movable member is connected with a movable lever of the utensil.
